(19) United States
(12) Patent Application Publication
(10) Pub. No.: US 2018/0033437 A1
(43) Pub. Date: Feb. 1, 2018

(54) MASSAGE MACHINE

(71) Applicant: FAMILY INADA CO., LTD., Osaka (JP)

(72) Inventor: Nichimu Inada, Osaka (JP)

(21) Appl. No.: 15/663,415

(22) Filed: Jul. 28, 2017

(30) Foreign Application Priority Data
Jul. 28, 2016 (JP) 2016-148069
Jun. 28, 2017 (JP) 2017-125729

(51) Int. Cl. G10L 15/26; H04M 11/00

(52) U.S. Cl. CPC G10L 15/26; H04M 11/007; A61H 15/00

(57) ABSTRACT

A massage machine includes a display unit or a voice output unit and a control unit that controls functions of the massage machine. The control unit includes control modes in which the functions assigned to each of the control modes are at least partially different from each other. The control modes include a full function control mode in which all or almost all of the functions are assigned, and a function limitation control mode in which the functions are at least partially limited. When the massage machine is in a predetermined state, the control unit proceeds to the function limitation control mode. In the function limitation control mode, the control unit causes the display unit to display information relating to the massage machine, or causes the voice output unit to output the information by using a voice. The information is receivable from a service provider.

### RELATED APPLICATION

This application claims the Paris Convention priority based on Japanese Patent Application Nos. 2017-125729 filed on Jun. 28, 2017 and 2016-148069 filed on Jul. 28, 2016, the contents of these applications of which, including the specifications, the claims and the drawings, are incorporated herein by reference in their entirety.

### TECHNICAL FIELD

The present invention relates to a massage machine.

### BACKGROUND ART

In general, massage machines are exhibited at stores such as home appliance mass merchandisers, and are on sale by a salesperson who explains features of the massage machine and a manual of the massage machine. However, according to the above-described sales method, the salesperson has to be allocated to every store, thereby leading to inefficient marketing. In order to solve this problem, a massage machine has been proposed which can output information including explanation of the manual of the machine by providing the massage machine with an image output device and an voice output device (for example, refer to JP-A-5-40873).

### SUMMARY OF THE INVENTION

A massage machine according to the present invention includes at least one of a display unit and a voice output unit and a control unit configured to control functions of the massage machine. The control unit includes data of control modes in which the functions assigned to each of the control modes are at least partially different from each other. The control modes include a full function control mode in which all or almost all of the functions are assigned, and a function limitation control mode in which the functions are at least partially limited. When the massage machine is in a predetermined state, the control unit proceeds to the function limitation control mode. In the function limitation control mode, the control unit causes the display unit to display information relating to the massage machine, or causes the voice output unit to output the information by using a voice. The information may be receivable from a service provider.

The information may include at least any one of features that include a manual, a price, and a purchase method of the massage machine.

### BRIEF DESCRIPTION OF THE DRAWINGS

FIG. 1 is a side view of a massage machine according to an embodiment of the present invention.

FIG. 2 is a front view of a massage unit.

FIG. 3 is a block diagram of the massage machine.

FIG. 4 is a view for describing a controller.

FIGS. 5A and 5B are views of a display unit. Respectively, FIG. 5A illustrates a state where a course selection key and a site selection key are displayed, and FIG. 5B illustrates a state where a procedure selection key is displayed.

FIGS. 6A and 6B are views of the display unit. Respectively, FIG. 6A illustrates a state in a function limitation control mode, and FIG. 6B illustrates a state in a full function control mode.

FIG. 7 is a flowchart for describing proceeding of a control mode.

FIG. 8 is a flowchart for describing proceeding of the control mode.

FIGS. 9A to 9C are views of the display unit. Respectively, FIG. 9A illustrates a state where an advertisement selection key is displayed, FIG. 9B illustrates a state where a person selection key and a character selection key are displayed, and FIG. 9C illustrates a voice selection key is displayed.

FIGS. 10A and 10B are views of the display unit. Respectively, FIG. 10A illustrates a state in the function limitation control mode, and FIG. 10B illustrates a state in the full function control mode.

FIG. 11 is a flowchart for describing proceeding of a control mode.

FIG. 12 is a flowchart for describing proceeding of the control mode.

FIG. 13 is an overall configuration diagram illustrating an information network system including the massage machine.

### DETAILED DESCRIPTION OF THE INVENTION

### Overall Configuration of Massage Machine

Hereinafter, an overall configuration of a massage machine 1 according to an embodiment of the present invention will be described.

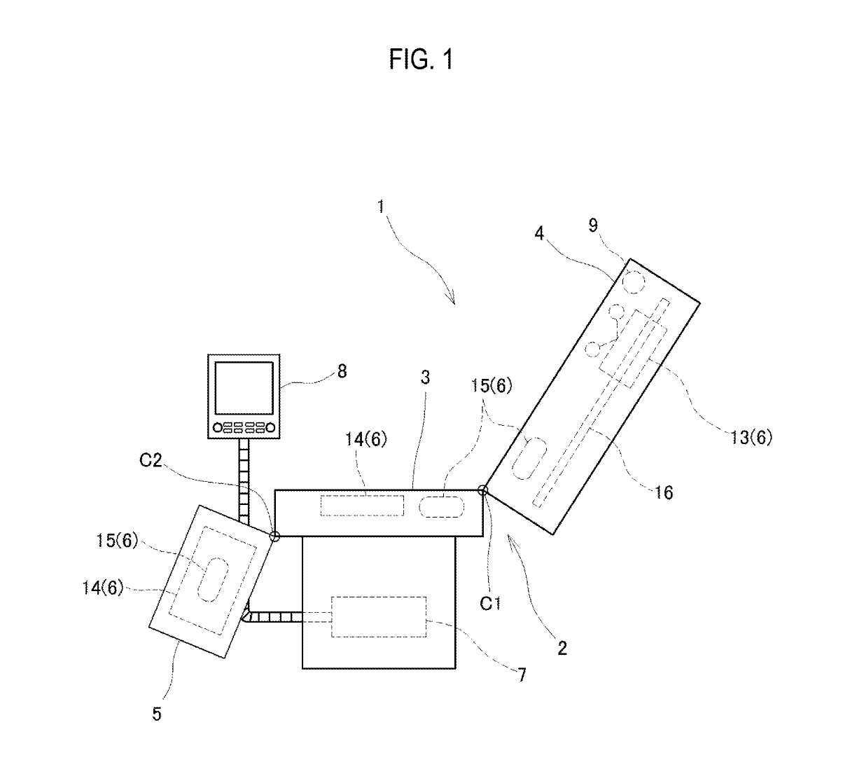

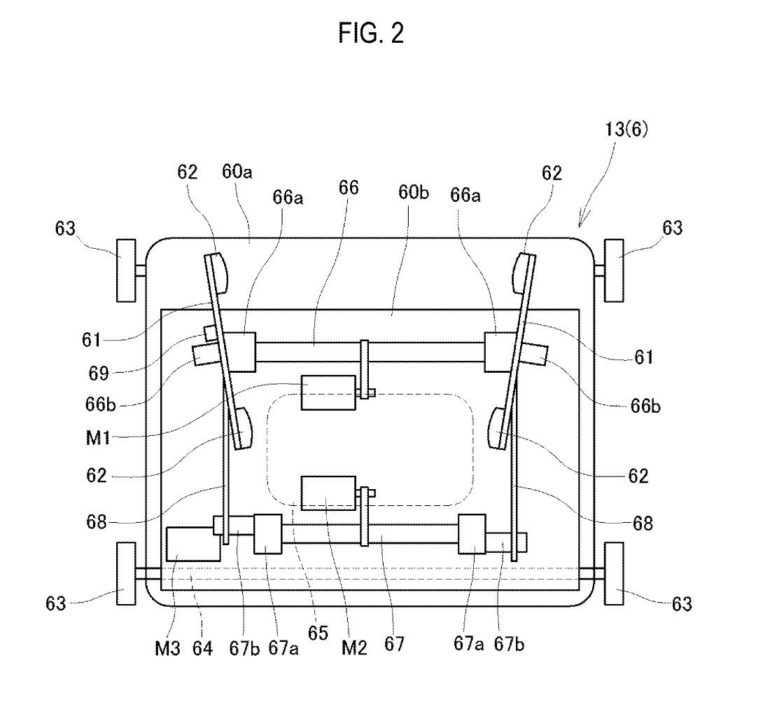

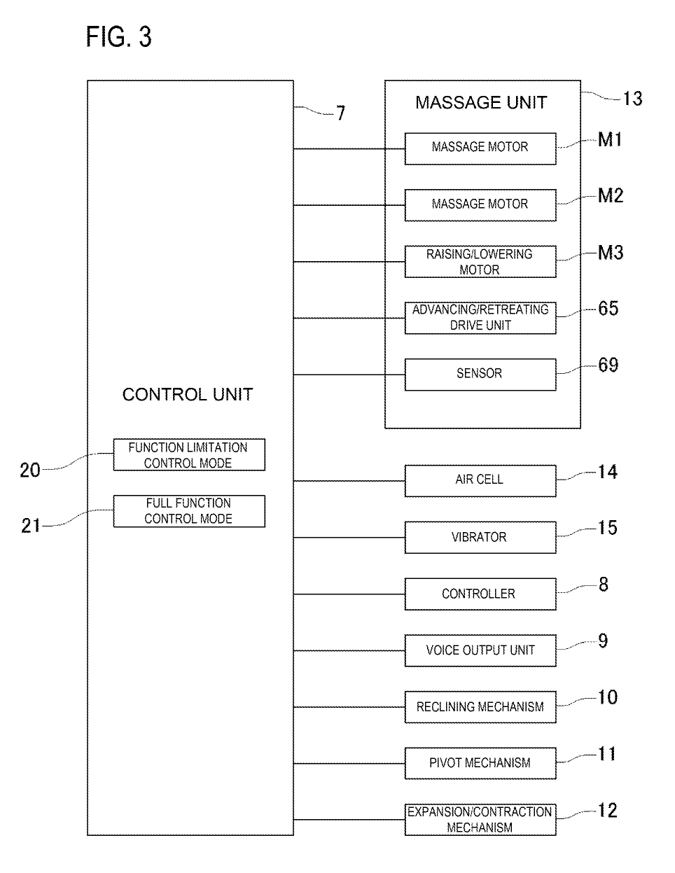

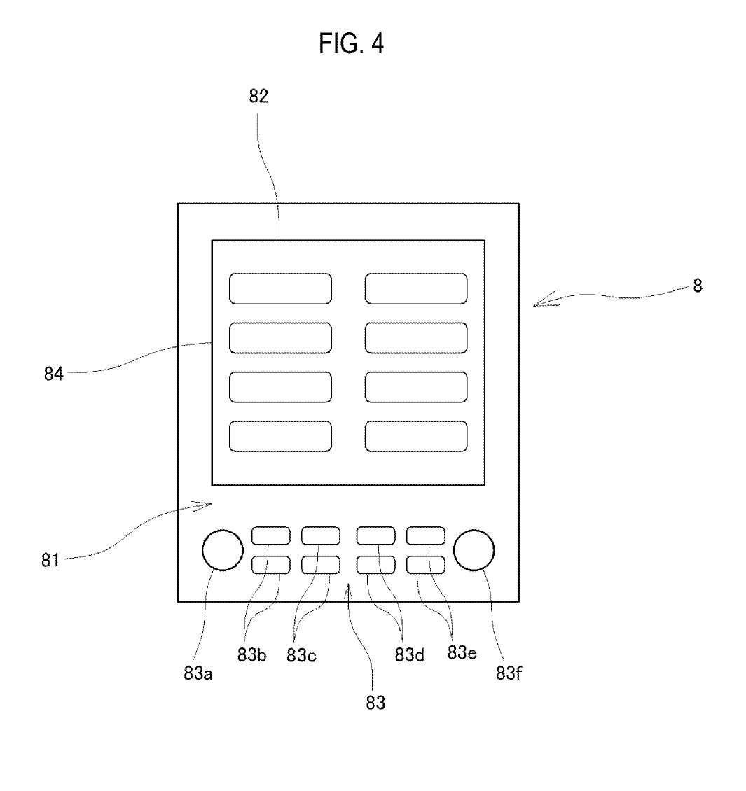

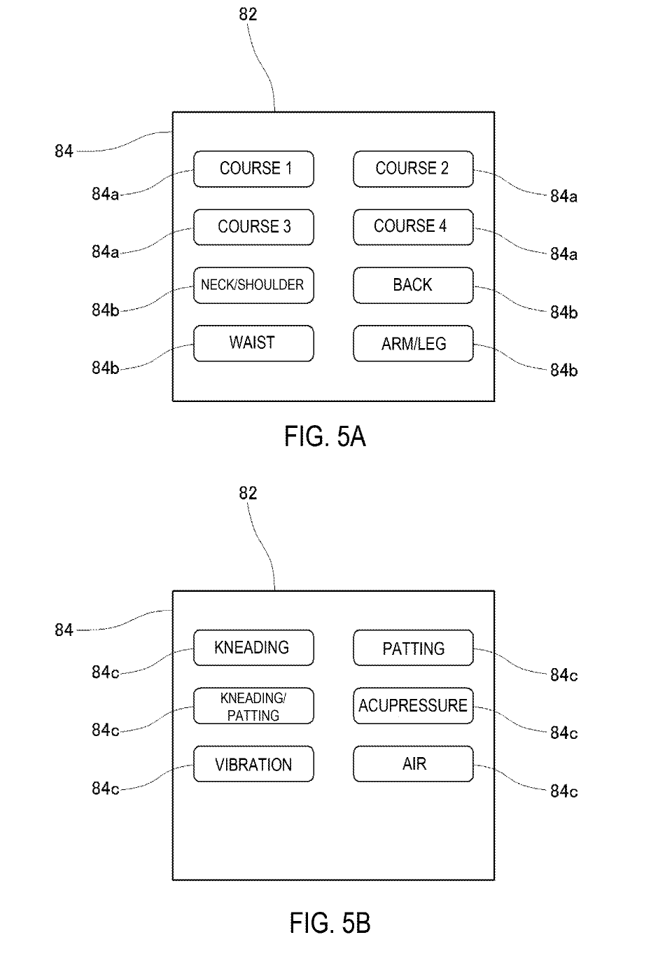

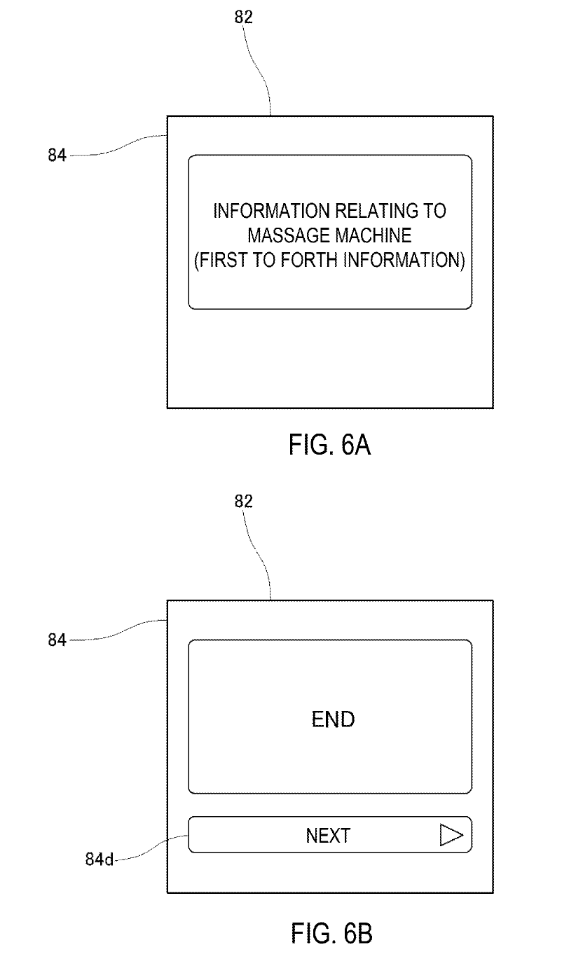

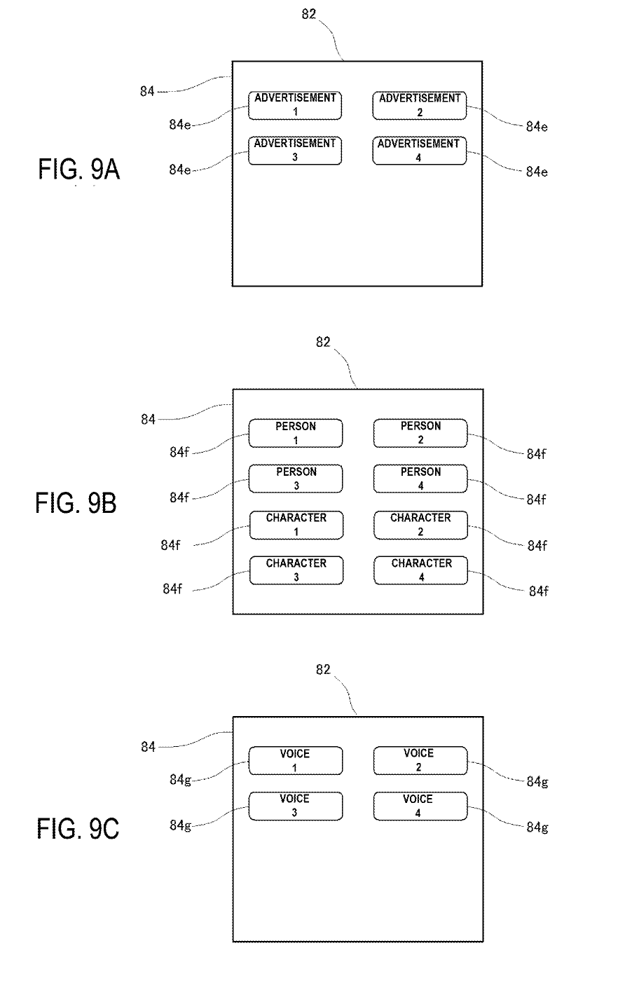

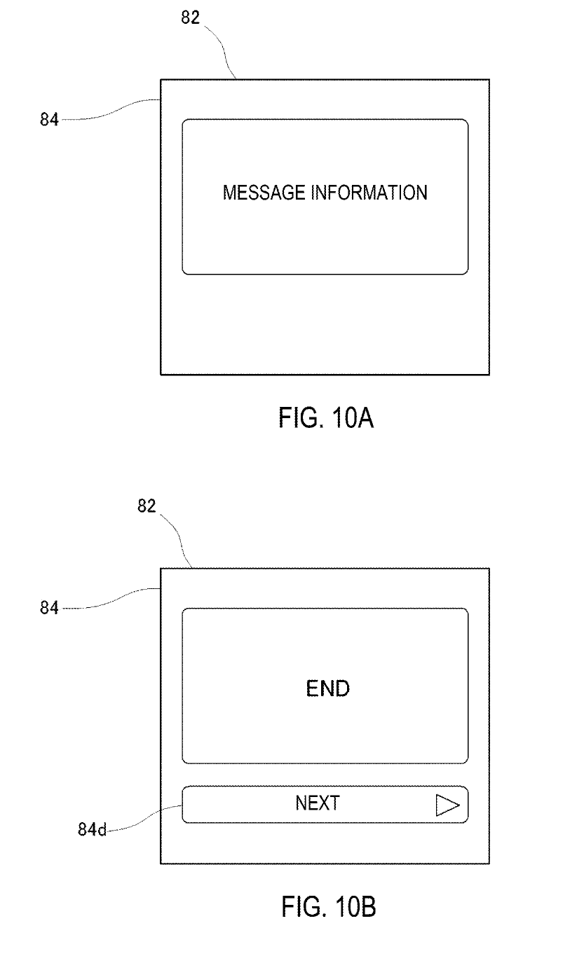

FIG. 1 is a side view of the massage machine 1 according to the embodiment of the present invention. FIG. 2 is a front view of a massage unit 13. FIG. 3 is a block diagram of the massage machine 1. FIG. 4 is a view for describing a controller 8. FIGS. 5A and 5B are views of a display unit 82. Respectively, FIG. 5A illustrates a state where a course selection key 84a and a site selection key 84b are displayed, and FIG. 5B illustrates a state where a procedure selection key 84c is displayed. FIGS. 6A and 6B are views of the display unit 82. Respectively, FIG. 6A illustrates a state in a function limitation control mode 20, and FIG. 6B illustrates a state in a full function control mode 21. FIGS. 9A-9C are views of the display unit 82. Respectively, FIG. 9A illustrates a state where an advertisement selection key 84e is displayed, FIG. 9B illustrates a state where a person selection key 84f and a character selection key 84f are displayed, and FIG. 9C illustrates a state where a voice selection key 84g is displayed. FIGS. 10A and 10B are views of the display unit 82. Respectively, FIG. 10A illustrates a state in the function limitation control mode 20, and FIG. 10B illustrates a state in the full function control mode 21.

As illustrated in FIGS. 1 to 3, the massage machine 1 according to the embodiment of the present invention has a main body unit 2 configured to include a seat unit 3 on which a user sits, a backrest unit 4 against which the user leans, which is disposed in a rear portion of the seat unit 3, and a foot rest 5 disposed in a front portion of the seat unit 3. In addition, the massage machine 1 has a massage unit 6 for massaging the user, a control unit 7 for controlling a function belonging to the massage machine 1, a controller 8 for performing various operations of the massage machine 1, and a voice output unit 9 including a speaker. The voice output unit 9 may be disposed in the vicinity of the head of the user who sits on the main body unit 2, or may be disposed in the controller 8. The main body unit 2 may have each armrest disposed on both sides of the seat unit 3, and the massage unit 6 may be disposed in the armrest.

It is preferable that an operation of a reclining mechanism 10 having an actuator enables backrest unit 4 to move (recline) in back and forth directions around a pivot shaft C1 which is disposed in the rear portion of the seat unit 3 and whose axial direction is right and left directions. It is preferable that an operation of a pivot mechanism 11 having an actuator enables the foot rest 5 to move (pivot) in up and down directions around a pivot shaft C2 which is disposed in the front portion of the seat unit 3 and whose axial direction is the right and left directions. It is preferable that an operation of an expansion/contraction mechanism 12 having an actuator enables the foot rest 5 to move (expand/contract) along a longitudinal direction of a lower leg.

The massage unit 6 has at least one of a massage unit 13 having a pair of right and left treatment devices 62 driven by motors M1 to M3, an air cell 14 which expands and contracts by supplying and discharging air, and a vibrator 15 driven by a motor. In the present embodiment, the massage unit 13 and the vibrator 15 are disposed in the backrest unit 4, and the air cell 14 and the vibrator 15 are disposed in the seat unit 3 and the foot rest 5. The arrangement of each massage unit 6 is not limited thereto. The air cell 14 can press a user by supplying and discharging the air. The vibrator 15 can give vibration to the user by rotating an eccentric weight.

Configuration of Massage Unit

As illustrated in FIG. 2, the backrest unit 4 has the massage unit 13 for massaging an upper body of the user from behind (rear surface). This massage unit 13 is configured to include a pair of right and left arms 61 and the treatment devices 62 respectively disposed in upper and lower ends of the arm 61. In this manner, it is possible to perform kneading massage in which the right and left treatment devices 62 move close to and away from each other by driving a massage motor M1, and patting massage in which the right and left treatment devices 62 alternately advance toward and retreat from the user by driving a massage motor M2. In addition, the massage unit 13 can move upward or downward along a height direction of the user by driving a raising/lowering motor M3. In this manner, it is possible to change a position relative to the user's body, or to perform rolling massage. The backrest unit 4 has a pair of right and left guide rails 16 (refer to FIG. 1) extending in the height direction of the user, and the massage unit 13 moves along the guide rails 16. Since the massage unit 13 is movable in the height direction of the user, the treatment devices 62 can massage a site between the neck and the waist of the user.

As illustrated in FIG. 2, the massage unit 13 has a base frame 60a and a movable frame 60b supported by the base frame 60a. The base frame 60a has guide rollers 63 respectively fitted to the guide rails 16 on both right and left sides thereof. Then, the massage unit 13 can move along the height direction of the user by a raising/lowering mechanism (not illustrated) having a rack pinion. The movable frame 60b is supported by the base frame 60a via an oscillation shaft 64 in the right and left directions. An advancing/retreating drive unit 65 having an air cell is disposed between the base frame 60a and the movable frame 60b. Driving the advancing/retreating drive unit 65 enables the movable frame 60b to advance toward and retreat from the user around the oscillation shaft 64. A structure may be adopted in which the movable frame 60b does not advance toward and retreat from the user. Alternatively, a structure may be adopted in which the advancing/retreating drive unit 65 is disposed in the arm 61 so that only the arm 61 advances toward and retreats from the user.

The arm 61 is connected to a kneading shaft 66 and a patting shaft 67 which extend in the right and left directions. An inclined cam 66a having an inclined shaft 66b is disposed on both right and left sides of the kneading shaft 66. The arm 61 is attached to the inclined cam 66a. The inclined shafts 66b on the right and left are inclined with respect to an axis of the kneading shaft 66 so as to have a substantially inverted V-shape in a front view. An eccentric cam 67a having an eccentric shaft 67b eccentric to the axis of the patting shaft 67 is disposed on both right and left sides of the patting shaft 67. The arm 61 is connected to the eccentric cam 67a via a connecting rod 68. The eccentric shafts 67b on the right and left have mutually different phases with respect to the axis of the patting shaft 67. Specifically, the phases are different from each other by 180 degrees. The kneading shaft 66 and the patting shaft 67 are rotated by respectively driving the massage motors M1 and M2. The treatment device 62 performs kneading massage by rotating the kneading shaft 66, and performs patting massage by rotating the patting shaft 67. The arm 61 having the treatment device 62, the kneading shaft 66, and the patting shaft 67 are supported by the movable frame 60b. Accordingly, the treatment device 62 can advance toward and retreat from the user via the movement of the movable frame 60b.

The arm 61 is capable of oscillation in the back and forth directions, and is biased by biasing means (not illustrated) having a spring so that the treatment device 62 on the upper side projects forward. In addition, as illustrated in FIG. 3, the massage unit 13 has a sensor 69 for detecting physical information of the user. The sensor 69 can obtain the physical information by detecting whether the arm 61 reaches a predetermined oscillation position. Specifically, if the treatment device 62 on the upper side reaches above the shoulder of the user in a course of raising the massage unit 13 along the height direction of the user, load acting on the treatment device 62 is released. As a result of an operation of biasing means (not illustrated), the arm 61 oscillates forward so as to reach the predetermined oscillation position. The sensor 69 detects that the arm 61 reaches the predetermined oscillation position. At this time, a position of the shoulder is detected based on up and down positions of the massage unit 13. Based on the position of the shoulder, a position of other sites (neck, back, and waist) is obtained using calculation. The detected physical information is stored in a storage unit of the control unit 7. The physical information may be input by the user himself or herself. In this case, for example, the controller 8 can be operated so as to input the physical information. The physical information can be stored in the storage unit of the control unit 7.

### Configuration of Control System

As illustrated in FIG. 3, the massage machine 1 has the control unit 7 including a microcomputer for operating the massage unit 13, the air cell 14, the vibrator 15, the reclining mechanism 10, the pivot mechanism 11, and the expansion/contraction mechanism 12. This control unit 7 is disposed under the seat unit 3, and is connected to the controller 8 operated by the user. The user operates the controller 8 so as to perform various massage operations.

As illustrated in FIG. 4, the controller 8 has an operation unit 81 for performing various operations of the massage machine 1, and a display unit 82 for displaying information relating to the massage machine 1. The operation unit 81 according to the present embodiment is configured to include a physical button 83 operated by the user pushing with the fingertip of the user, and a touch panel 84 operated by the user with the fingertip of the user. The display unit 82 according to the present embodiment is configured to include the touch panel 84, and also functions as the operation unit 81. The display unit 82 may be disposed independently of the controller 8.

As the physical button 83, there are provided a “power button 83a” for actuating or stopping the massage machine by switching power supply states, a “position adjustment button 83b” for changing a position of the massage unit 13, a “reclining button 83c” for changing a posture of the backrest unit 4, a “pivot button 83d” for changing a posture of the foot rest 5, an “expansion/contraction button 83e” for changing a length of the foot rest 5, and an “urgent stop button 83f” for urgently stopping all operations of the massage machine 1 during the operation.

As illustrated in FIGS. 5A, 5B, and 9A to 9C, the touch panel 84 can change a screen by a predetermined operation or with the lapse of time. Types of operation keys displayed on each screen are different from each other. One or more operation keys are displayed on one screen. It is preferable that the touch panel 84 includes one or more operation keys for operating the massage unit 6 or the message information. For example, the operation keys for operating the massage unit 6 include a “course selection key 84a” for selecting a massage course for operating each massage unit 6 in accordance with a predetermined program, a “site selection key 84b” for selecting the massage unit 6 to be operated among a plurality of the massage units 6, or a “procedure selection key 84c” for selecting a massage procedure performed by the massage unit 6. In addition, for example, operation keys for operating the message information include an “advertisement selection key 84e” for selecting an advertisement to be displayed on the display unit, a “person selection key 84f” or a “character selection key 84f” for selecting a person or a character to be displayed on the display unit, and a “voice selection key 84g” for selecting a voice to be output by the voice output unit.

In the present embodiment, the operation unit 81 is configured so that the physical button 83 and the touch panel 84 are combined with each other. However, the operation unit 81 corresponding to the respective buttons 83a to 83f and the respective operation keys 84a to 84c may be configured to include only the physical button 83 or only the touch panel 84.

As illustrated in FIG. 3, a plurality of the control modes for controlling the function belonging to each massage unit 6 are prepared, and an operation program for operating the massage unit 6 in accordance with the control mode is stored in a storage unit including a RAM and a ROM which are disposed in the control unit 7. Then, the user operates the operation unit 81 so that the control unit 7 operates the respective massage units 6 and the respective mechanisms 10 to 12. Furthermore, the control unit 7 has a plurality of the control modes in which the functions available to the user are partially different from each other in all functions of the massage machine 1. A plurality of the control modes include the full function control mode 21 in which the user can use all functions of the massage machine 1, and the function limitation control mode 20 in which the functions available to the user are partially limited in the full function control mode 21. In addition, the control unit 7 is configured so that the massage unit 6 can perform a plurality of different massage courses operated in accordance with a predetermined program.

In the full function control mode 21, it is possible to select and operate all of the massage unit 13, the air cell 14, the vibrator 15, the reclining mechanism 10, the pivot mechanism 11 and the expansion/contraction mechanism 12 which are the functions belonging to the massage machine 1. That is, in the full function control mode 21, all operations of the power button 83a, the position adjustment button 83b, the reclining button 83c, the pivot button 83d, the expansion/contraction button 83e, and the urgent stop button 83f are set to be valid. All of the course selection key 84a, the site selection key 84b, and the procedure selection key 84c which relate to the operation of the massage unit 6 are displayed on the display unit 82, and the operation is set to be valid.

In the function limitation control mode 20, the functions available to the user are at least partially limited in the full function control mode 21. In other words, it is not possible to entirely or partially select and operate the functions of the massage unit 13, the air cell 14, the vibrator 15, the reclining mechanism 10, the pivot mechanism 11 and the expansion/contraction mechanism 12 which are the functions belonging to the massage machine 1. Specifically, in the function limitation control mode 20, the operation of the position adjustment button 83b which relate to the operation of the massage unit 6 is set to be invalid. In addition, as illustrated in FIG. 6A, all of the course selection key 84a, the site selection key 84b, and the procedure selection key 84c which relate to the operation of the massage unit 6 are set so as not to be displayed on the display unit 82. On the other hand, the operation of the power button 83a, the reclining button 83c, the pivot button 83d, the expansion/contraction button 83e, and the urgent stop button 83f which do not relate to the operation of the massage unit 6 is set to be valid.

In the function limitation control mode 20, as another method for not operating the operation unit 81 configured to include the touch panel 84, the operation keys 84a to 84g are displayed on the display unit 82. However, the operation using the finger of the user may be set to be invalid. In addition, in the function limitation control mode 20, at least any one operation of the power button 83a, the reclining button 83c, the pivot button 83d, and the expansion/contraction button 83e which do not relate to the operation of the massage unit 6 may be set to be invalid.

The massage machine 1 according to the present invention can provide information relating to the massage machine 1 or the message information issued from the service provider who installs the massage machine 1. As the information relating to the massage machine 1, it is preferable that at least any one of the following four pieces of information is included. The first information includes information relating to features of the massage machine 1, such as the function provided for the massage machine 1 and the efficacy and effect which are provided for the user. In other words, the first information is a selling point of this massage machine 1. The second information includes information relating to a manual of the massage machine 1, such as a method of adjusting the posture of the backrest unit 4 or the foot rest 5 and a method of selecting a massage course. The third information includes information relating to a price of the massage machine 1. The fourth information includes information relating to a purchase method of the massage machine 1, such as guidance on a purchase application form, guidance on a lease contract, or guidance on inquiry destination. In addition, it is preferable that the message information issued from the service provider who installs the massage machine is an advertisement issued from the service provider. For example, the message information issued from the service provider who installs the massage machine includes advertisement information relating to the service provider's own introduction, or the service provider's handling products or services, and advertisement information relating to events hosted by the service provider.

The information relating to the massage machine 1 will be described. As illustrated in FIG. 6A, the information relating to the massage machine 1 is displayed as a moving image or a character on the display unit 82 belonging to the above-described controller 8. This moving image or character may be displayed on the display unit 82 which is disposed independently of the controller 8. In addition, guidance corresponding to the moving image is output by using a voice from the voice output unit 9. The information relating to the massage machine 1 is provided in the function limitation control mode 20. When the control mode proceeds to the function limitation control mode 20, the control unit 7 controls the display unit 82 and the voice output unit 9 so as to display the information relating to the massage machine 1 and to output the voice. In the function limitation control mode 20 while the information relating to the massage machine 1 is provided, the operation keys 84a to 84c relating to the operation of the massage unit 6 are not displayed. However, if the information relating to the massage machine 1 is completely provided, the control mode proceeds to the full function control mode 21. As illustrated in FIG. 6B, a proceeding key 84d written as “Next” for proceeding to a screen on which the operation keys 84a to 84c are displayed is displayed, and the operation is validated.

### Proceeding Flow of Control Mode

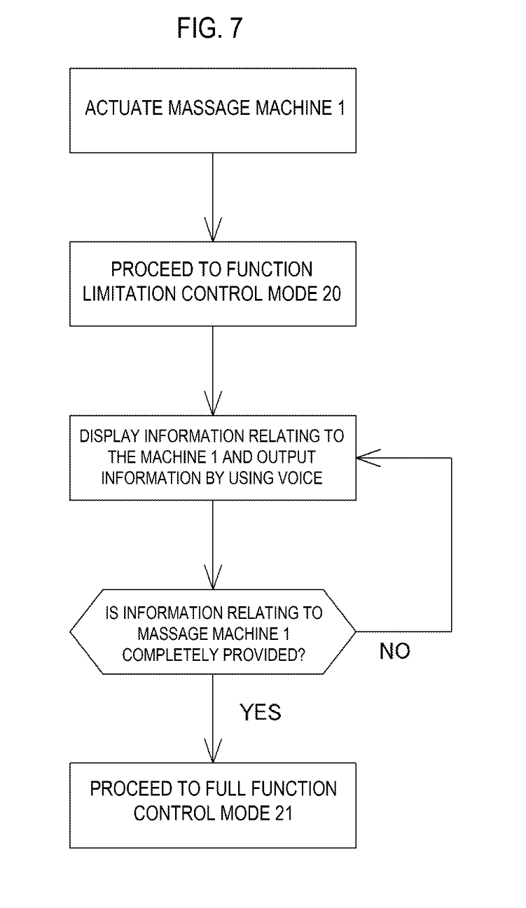

Hereinafter, a proceeding flow of the respective control modes 20 and 21 will be described. FIG. 7 is a flowchart for describing the proceeding of the control mode.

As illustrated in FIG. 7, first, the power button 83a is operated so as to actuate the massage machine 1. If the massage machine 1 is actuated, the control mode proceeds to the function limitation control mode 20. As described above, in the function limitation control mode 20, the operation of the button 83b and/or the respective operation keys 84a to 84c which relate to the operation of the massage unit 6 is limited. If the control mode proceeds to the function limitation control mode 20, as illustrated in FIG. 6A, the control unit 7 controls the display unit 82 and the voice output unit 9 so as to display and output the information relating to the massage machine 1. Preferably, the information provided here is the first information relating to the features of the above-described massage machine 1 and/or the second information relating to the manual of the massage machine 1. If the information relating to the massage machine 1 is completely provided, the control mode proceeds to the full function control mode 21, and the display unit 82 shows a screen illustrated in FIG. 6B.

Proceeding to the function limitation control mode 20 is not limited to when the operation to actuate the massage machine 1 is performed. For example, when the operation keys 84a to 84c for operating the massage unit 6 are operated in a state where the massage machine 1 is actuated, the control mode may proceed to the function limitation control mode 20. Alternatively, a sensor (not illustrated) may be disposed in the seat unit 3 or the backrest unit 4 so that the control mode proceeds to the function limitation control mode 20 when contact between the user and the massage machine 1 is detected.

In this way, since the control mode forcibly proceeds to the function limitation control mode 20 before the massage machine 1 is used (massage starts), even if a salesperson is not present, the information relating to the features or the manual of the massage machine 1 can be reliably given to the user. Therefore, it is possible to properly use the massage machine 1. In addition, before the information relating to the massage machine 1 is given to the user, it is possible to prevent the user from leaving the massage machine 1, thereby expanding sales opportunities. Even in the function limitation control mode 20, since the operation to move the backrest unit 4 and the foot rest 5 is not limited, the user can obtain the information relating to the massage machine 1 while adopting a desired posture.

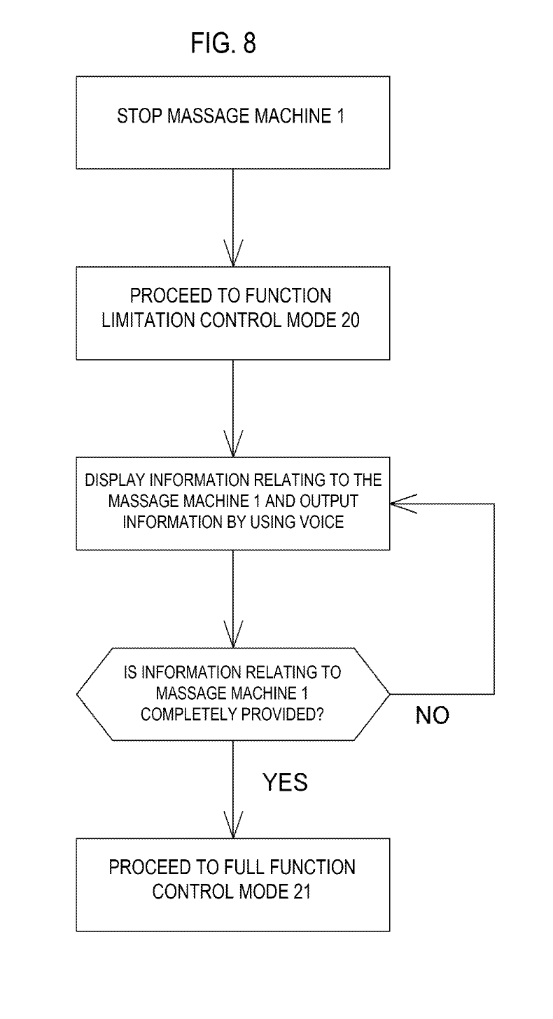

Hereinafter, a flow to the other respective control modes 20 and 21 will be described. FIG. 8 is a flowchart for describing the proceeding of the control mode.

As illustrated in FIG. 8, first, the power button 83a or the urgent stop button 83f is operated so as to stop the actuated massage machine 1. If the massage machine 1 is stopped, the control mode proceeds to the function limitation control mode 20. As described above, in the function limitation control mode 20, the operation of the button 83b and/or the respective operation keys 84a to 84c which relate to the operation of the massage unit 6 is limited. If the control mode proceeds to the function limitation control mode 20, as illustrated in FIG. 6A, the control unit 7 controls the display unit 82 and the voice output unit 9 so as to display and output the information relating to the massage machine 1. Preferably, the information provided here is the third information relating to the price of the above-described massage machine 1 and/or the fourth information relating to the purchase method of the massage machine 1. If the information relating to the massage machine 1 is completely provided, the control mode proceeds to the full function control mode 21, and the display unit 82 shows a screen illustrated in FIG. 6B.

Proceeding to the function limitation control mode 20 is not limited to when the operation to stop the massage machine 1 is performed. For example, the control mode may proceed to the function limitation control mode 20 when the massage course is completed after a predetermined time elapses. In this way, even after the massage machine 1 is used (after the massage is completed), since the control mode forcibly proceeds to the function limitation control mode 20, even if a salesperson is not present, the information relating to the price of the massage machine 1 or the purchase method can be given to the user, thereby expanding sales opportunities. Even in the function limitation control mode 20, since the operation to move the backrest unit 4 and the foot rest 5 is not limited, the user can obtain the information relating to the massage machine 1 while adopting a desired posture.

The message information issued from the service provider who installs the massage machine will be described. As illustrated in FIG. 10A, the message information issued from the service provider who installs the massage machine is displayed as a moving image or a character on the display unit 82 belonging to the above-described controller 8. This moving image or character may be displayed on the display unit 82 which is disposed independently of the controller 8. When displayed on the display unit 82, it is preferable to display a plurality of persons or a plurality of characters together with the moving image. The person selection key 84f or the character selection key 84f serving as a selection unit is selected (to be described later). In this way, it is preferable that the user can select any desired person or character from among a plurality of the displayed persons or a plurality of the displayed characters. According to this configuration, it is possible to cause the display unit 82 to display the user's selected favorite person or character. Therefore, the user can feel a sense of friendliness.

In addition, guidance corresponding to the moving image is output by using a voice from the voice output unit 9. When this voice is output, the voice selection key 84g is selected (to be described later). In this way, it is preferable that the user can select any desired voice from a plurality of voices. According to this configuration, it is possible to cause the voice output unit 9 to output the user's selected favorite voice. Therefore, the user can feel a sense of more friendliness.

The message information issued from the service provider who installs the massage machine is provided in the function limitation control mode 20. If the control mode proceeds to the function limitation control mode 20, the control unit 7 controls the display unit 82 and the voice output unit 9 so as to display the respective operation keys 84e to 84g serving as selection units on the display unit 82.

A flow of the respective operation keys 84e to 84g serving as the selection units is as follows. For example, the user selects any desired advertisement (advertisement 1) from the advertisement selection key 84e (advertisements 1 to 4) displayed on the display unit 82. If the advertisement 1 is selected, the mode is switched to a screen for selecting the person selection key 84f or the character selection key 84f. The user selects any desired person (person 3) from the person selection key 84f (persons 1 to 4) or the character selection key 84f (characters 1 to 4). If the person 3 is selected, the mode is switched to a screen for selecting the voice selection key 84g. The user selects any desired voice (voice 2) from the voice selection key 84g (voices 1 to 4).

The user selects all of these in this way. Accordingly, the user can confirm the user's desired message information (advertisement 1) issued from the service provider through the user's favorite person (person 3) and the user's favorite voice (voice 2).

In the above-described example, a case has been described where the advertisement selection key 84e, the person selection key 84f or the character selection key 84f, and the voice selection key 84g are sequentially selected. However, the present invention is not limited thereto. That is, the respective selection keys 84e to 84g may be combined with each other in a case where the advertisement selection key 84e and the person selection key 84f or the character selection key 84f are selected, or in a case where the advertisement selection key 84e and the voice selection key 84g are selected. Alternatively, the respective selection keys 84e to 84g may be independently selected. A case will be described where the respective selection keys 84e to 84g are independently selected. For example, in a case where the advertisement selection key 84e is independently selected, a person or a character and a voice which relate to the selected advertisement are automatically determined. That is, the person or the character and the voice are determined by the user simply selecting the advertisement selection key 84e. In addition, in a case where the person selection key 84f or the character selection key 84f is independently selected, the advertisement and the person or the character which relate to the selected voice are automatically determined. That is, the advertisement and the voice are determined by the user simply selecting the person selection key 84f or the character selection key 84f. In addition, in a case where the voice selection key 84g is independently selected, the advertisement and the person or the character which relate to the voice are automatically determined. That is, the advertisement and the person or the character are determined by the user simply selecting the voice selection key 84g.

According to this configuration, it is possible to ease the user's discomfort in respectively selecting the advertisement and the person or the character and the voice.

For example, the advertisement which can be selected using the advertisement selection key 84e includes sales information of products or services handled by the service provider who installs the massage machine 1, and event information hosted by the service provider. In this way, the products or the services handled by the service provider who installs the massage machine 1 can appeal to the user. Accordingly, sales opportunities can be expanded. For example, the person or the character which can be selected using the person selection key 84f or the character selection key 84f is an announcer, an actor, an actress, an entertainer, or an animation character. In this way, the user can feel a sense of more friendliness. For example, the voice which can be selected using the voice selection key 84g is a male voice, a female voice, or a synthesized voice generated using a machine such as Vocaloid (registered trademark). In this way, the user can feel a sense of more friendliness.

### Proceeding Flow of Control Mode

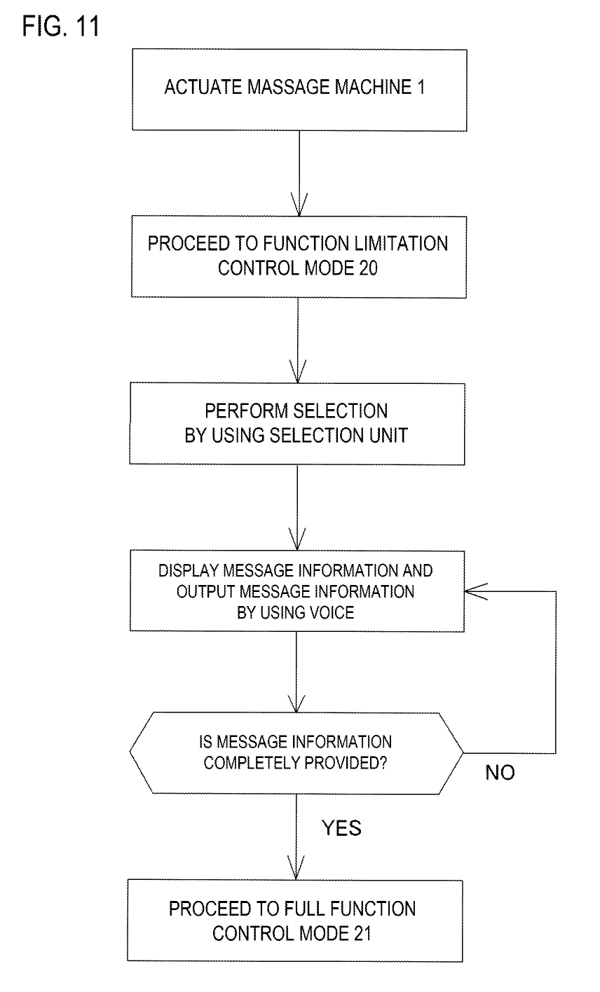

Hereinafter, a proceeding flow of the respective control modes 20 and 21 will be described. FIG. 11 is a flowchart for describing the proceeding of the control mode.

As illustrated in FIG. 11, first, the power button 83a is operated so as to actuate the massage machine 1. If the massage machine 1 is actuated, the control mode proceeds to the function limitation control mode 20. As described above, in the function limitation control mode 20, the operation of the button 83b and/or the respective operation keys 84a to 84c which relate to the operation of the massage unit 6 is limited. If the control mode proceeds to the function limitation control mode 20, as illustrated in FIGS. 9A to 9C, the user selects the advertisement selection key 84e, the person selection key 84f or the character selection key 84f, and the voice selection key 84g which serve as the selection units, respectively. In accordance with the selected content, as illustrated in FIG. 10A, the control unit 7 controls the display unit 82 and the voice output unit 9 so as to display and output the message information issued from the service provider. Here, it is preferable that the provided information is the advertisement issued from the above-described service provider. If the message information is completely provided from the service provider, the control mode proceeds to the full function control mode 21, and the display unit 82 is switched to a screen illustrated in FIG. 10B.

Proceeding to the function limitation control mode 20 is not limited to when the operation to actuate the massage machine 1 is performed. For example, when the operation keys 84a to 84c for operating the massage unit 6 are operated in a state where the massage machine 1 is actuated, the control mode may proceed to the function limitation control mode 20. Alternatively, a sensor (not illustrated) may be disposed in the seat unit 3 or the backrest unit 4. In this way, the control mode proceeds to the function limitation control mode 20 when contact between the user and the massage machine 1 is detected.

In this way, the control mode forcibly proceeds to the function limitation control mode 20 before the massage machine 1 is used (massage starts). Accordingly, even if the salesperson is not present, the message information (for example, advertisement of the service provider or calling the user's attention to matters when the user uses the massage machine) issued by the service provider who installs the massage machine can be reliably given to the user. Therefore, the message information issued from the service provider can be properly understood by the user. In addition, before the message information issued from the service provider who installs the massage machine is given to the user, it is possible to prevent the user from leaving the massage machine 1, thereby maximizing an advertising effect. Even in the function limitation control mode 20, since the operation to move the backrest unit 4 and the foot rest 5 is not limited, the user can obtain the message information issued from the service provider who installs the massage machine, while adopting a desired posture.

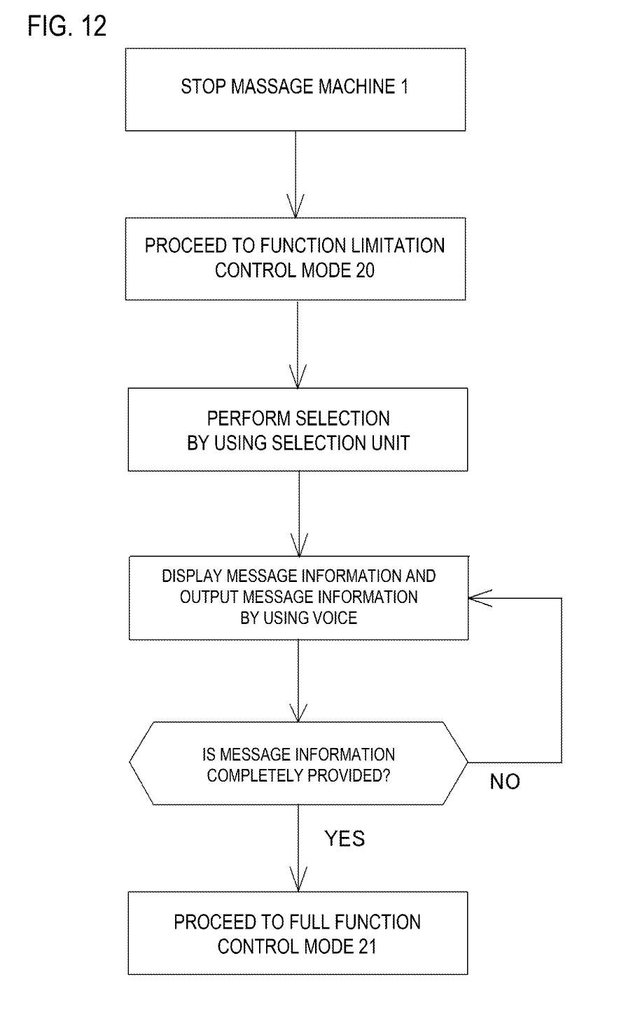

Hereinafter, a flow to the other respective control modes 20 and 21 will be described. FIG. 12 is a flowchart for describing the proceeding of the control mode.

As illustrated in FIG. 12, first, the power button 83a or the urgent stop button 83f is operated so as to stop the actuated massage machine 1. If the massage machine 1 is stopped, the control mode proceeds to the function limitation control mode 20. As described above, in the function limitation control mode 20, the operation of the button 83b and/or the respective operation keys 84a to 84c which relate to the operation of the massage unit 6 is limited. If the control mode proceeds to the function limitation control mode 20, the advertisement selection key 84e, the person selection key 84f or the character selection key 84f, and the voice selection key 84g which serve as the selection units are respectively selected by the user. In accordance with the selected content, as illustrated in FIG. 10A, the control unit 7 controls the display unit 82 and the voice output unit 9 so as to display and output the message information issued from the service provider who installs the massage machine. Preferably, the information provided here is the advertisement issued from the above-described service provider. If the message information issued from the service provider who installs the massage machine is completely provided, the control mode proceeds to the full function control mode 21, and the display unit 82 is switched to a screen illustrated in FIG. 10B.

Proceeding to the function limitation control mode 20 is not limited to when the operation to stop the massage machine 1 is performed. For example, the control mode may proceed to the function limitation control mode 20 when the massage course is completed after a predetermined time elapses. In this way, the control mode forcibly proceeds to the function limitation control mode 20 after the massage machine 1 is used (massage is completed). Accordingly, even if the salesperson is not present, the message information (for example, advertisement of the service provider or calling the user's attention to matters when the user uses the massage machine) issued by the service provider who installs the massage machine can be reliably given to the user, thereby maximizing an advertising effect. Even in the function limitation control mode 20, since the operation to move the backrest unit 4 and the foot rest 5 is not limited, the user can obtain the message information issued from the service provider who installs the massage machine 1, while adopting a desired posture.

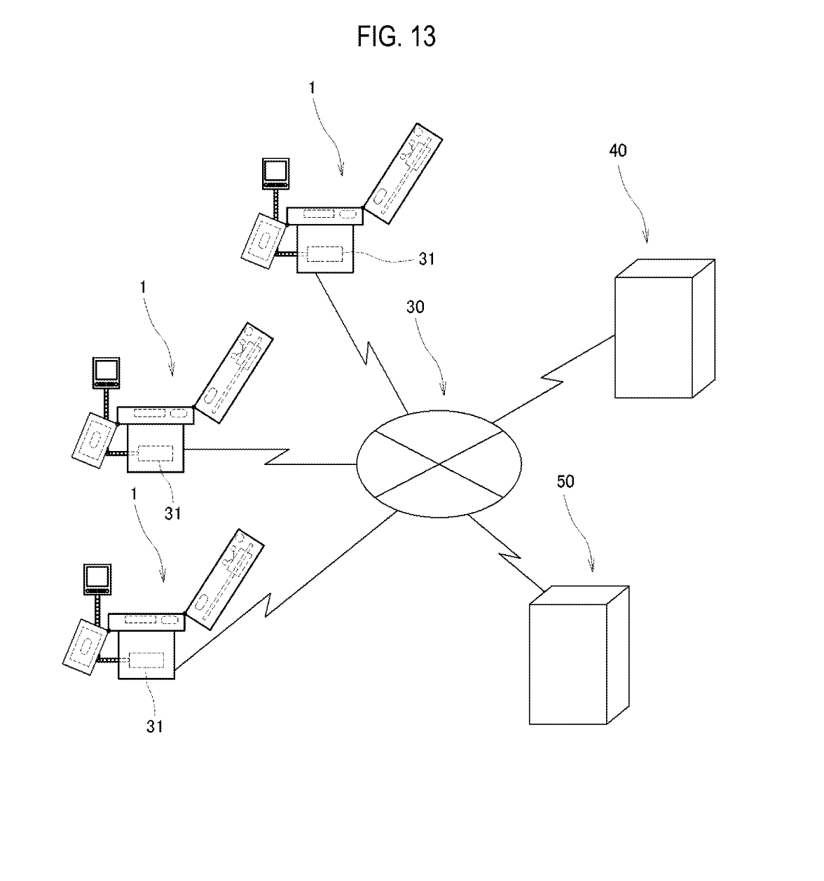

In addition, the massage machine 1 according to the present invention is not limited to the illustrated form, and may employ another form within the scope of the present invention. FIG. 13 is an overall configuration diagram illustrating an information network system including the massage machine 1.

For example, as illustrated in FIG. 13, the massage machine 1 may have communication means 31 which receives information from the outside. In this case, it is preferable that a communication network 30 includes the massage machine 1, a service provider 40, and a communication server 50. For example, in addition to the service provider who installs the massage machine 1, the service provider 40 includes a service provider who sells the massage machine 1, a service provider who rents the massage machine 1 to a user, or a service provider who provides maintenance service for the sold massage machine 1. Specifically, the service provider is an electronics retail store, a general merchandise store (GMS), a mail order firm, a wholesaler, a manufacturer company (manufacturer) which manufactures the massage machine 1, and a leasing company or a rental company which rents the massage machine 1 to the user. The communication server 50 is configured to communicate with the massage machine 1 via the communication network 30. For example, the communication network 30 includes an internet network, a communication network in a building, and a network within a region. In the present embodiment, the service provider 40 has a cloud-type communication server 50. The communication server 50 may be the communication server 50 managed by the service provider 40, or the communication server 50 managed by other service providers. The communication server 50 transmits the information relating to the massage machine 1 (the above-described first to fourth information). According to this configuration, the above-described information can easily correspond to a change in the massage machine 1, such as functional improvement and price revision.

In addition, the communication server 50 may transmit the message information issued from the service provider who installs the massage machine 1. According to this configuration, the information can easily correspond to a change in the information such the service provider's own introduction, and the service provider's handling products or services, and the advertisement of events hosted by the service provider.

In addition, the massage machine 1 may be able to interact with the user. In this case, it is preferable to provide voice recognition means for recognizing a voice output from the user, and it is preferable that an artificial intelligence technology is included in the control unit 7. According to this configuration, it is possible to interact with the user via the display unit 82 or the voice output unit 9. Therefore, the information relating to the massage machine 1 or the message information issued from the service provider who installs the massage machine 1 can be more properly given to the user.

The present invention can be applied to the massage machine which can sufficiently give the information relating to the massage machine to a user, even if a salesperson is not present, or a massage machine in which message information (for example, advertisement of a service provider or calling the user's attention to matters when the user uses the massage machine) issued by a service provider who installs the massage machine can be sufficiently given to the user, even if the service provider is not present.

Hereinbefore, embodiments of the present invention are described. It should be understood that the invention is not limited to the above-described embodiment, but may be modified into various forms on the basis of the spirit of the invention. Additionally, the modifications are included in the scope of the invention.

What is claimed is:

1. A massage machine comprising:
at least one of a display unit and a voice output unit; and
a control unit configured to control functions of the massage machine,
wherein the control unit includes data of control modes in which the functions assigned to each of the control modes are at least partially different from each other,
wherein the control modes include a full function control mode in which all or almost all of the functions are assigned, and a function limitation control mode in which the functions are at least partially limited,
wherein when the massage machine is in a predetermined state, the control unit proceeds to the function limitation control mode,
wherein in the function limitation control mode, the control unit causes the display unit to display information relating to the massage machine, or causes the voice output unit to output the information by using a voice,
wherein the information is receivable from a service provider.

2. The massage machine according to claim 1,
wherein the information includes at least any one of features that include a manual, a price, and a purchase method of the massage machine.

3. The massage machine according to claim 1,
wherein the message information is an advertisement issued from the service provider.

4. The massage machine according to claim 1,
wherein, when an operation for actuating the massage machine is performed, the control unit proceeds to the function limitation control mode.

5. The massage machine according to claim 1,
wherein, when an operation for operating the massage unit is performed, the control unit proceeds to the function limitation control mode.

6. The massage machine according to claim 1,
wherein, when it is detected that a user and the massage machine are in contact with each other, the control unit proceeds to the function limitation control mode.

7. The massage machine according to claim 1,
wherein when an operation for stopping the massage machine is operated, the control unit proceeds to the function limitation control mode.

8. The massage machine according to claim 1,
wherein, when a massage course is completed, the control unit proceeds to the function limitation control mode.

9. The massage machine according to claim 1 further comprising an operation unit configured to perform operations of the massage machine;
wherein the operation unit includes a touch panel or a physical button, and
wherein in the function limitation control mode, the control unit controls the operation unit so that an operation performed by the operation unit is invalidated, or so that the operation unit is not displayed.

10. The massage machine according to claim 1,
wherein in the function limitation control mode, the control unit performs control so that an operation for the massage unit is limited.

11. The massage machine according to claim 1, further comprising:
a backrest unit against which a user is configured to lean; or
a foot rest configured to support a leg of the user,
wherein in the function limitation control mode, the control unit performs control so that an operation for moving the backrest unit or the foot rest is not limited.

12. The massage machine according to claim 1 further comprising an operation unit configured to perform operations of the massage machine;
wherein the operation unit further includes a selection unit which can select information to be displayed on the display unit and/or information to be output by the voice output unit.

13. The massage machine according to claim 12,
wherein the selection unit can select a person or a character for delivering the information to be displayed on the display unit, from a plurality of the persons or a plurality of the characters.

14. The massage machine according to claim 12,
wherein the selection unit can select a voice for delivering the information to be output by the voice output unit, from a plurality of the voices.

15. The massage machine according to claim 1, further comprising:
communication means for communicating with the outside,
wherein the information can be acquired via the communication means.
